(19) United States
(12) Patent Application Publication
(10) Pub. No.: US 2020/0142163 A1
(43) Pub. Date: May 7, 2020

(54) IMAGE CAPTURING DEVICE

(71) Applicant: Primax Electronics Ltd., Taipei (TW)

(72) Inventors: Yun-Yi Lin, Taipei (TW); Mu-Jung Wang, Taipei (TW)

(21) Appl. No.: 16/255,568

(22) Filed: Jan. 23, 2019

(30) Foreign Application Priority Data
Nov. 2, 2018 (TW) 107139012

(51) Int. Cl. G02B 13/00; G02B 9/60

(52) U.S. Cl. CPC G02B 13/0045; G02B 9/60

(57) ABSTRACT

An image capturing device includes an optical lens module and an optical sensor. The optical lens module includes a first optical lens, a second optical lens, a third optical lens, a first combined lens assembly and a second combined lens assembly. The first combined lens assembly is a combination of a first glass lens and a silicone lens. The optical sensor is located beside the optical lens module. After the light beam passing through the optical lens module is received by the optical sensor, an image corresponding to a target object is generated.

### FIELD OF THE INVENTION

The present invention relates to an image pickup device, and more particularly to an image pickup device installed on a portable electronic device.

### BACKGROUND OF THE INVENTION

Recently, with development of electronic industries and advance of industrial technologies, various electronic devices are designed toward small size, light weightiness and easy portability. Consequently, these electronic devices can be applied to mobile business, entertainment or leisure purposes whenever or wherever the users are. For example, various image capturing devices are widely used in many kinds of fields such as smart phones, tablet computers, wearable electronic devices or any other appropriate portable electronic devices. Since the electronic devices are small and portable, users can use the image capturing devices of the electronic devices to capture images and store the images according to the users' requirements.

The image capturing device of the portable electronic device can be used to capture images at any time in order to record the life in pieces. Consequently, most users pay much attention to the image capturing device. Moreover, for allowing the image capturing devices to be favored by most people, the manufacturers make efforts in increasing the functions of the image capturing devices.

The structure of a conventional image capturing device will be described as follows. FIG. 1 is a schematic cross-sectional side view illustrating the structure of a conventional image capturing device. The conventional image capturing device 1 comprises an optical lens 11, an optical sensor 12 and a casing 13. After a light beam L passes through the optical lens 11, the light beam L enters the inner portion of the conventional image capturing device 1. The optical sensor 12 is aligned with the optical lens 11. When the light beam L passing through the optical lens 11 is sensed by the optical sensor 12, a corresponding image signal is generated. Consequently, an image corresponding to the image signal is displayed on a display device (not shown) that is connected with the image capturing device 1. The optical lens 11 and the optical sensor 12 are accommodated and positioned within the casing 13. Consequently, the optical lens 11 and the optical sensor 12 can be normally operated. Moreover, the casing 13 has an opening 131. The optical lens 11 is exposed outside through the opening 131, so that the light beam L is allowed to pass through the optical lens 11.

The optical lens 11 of the image capturing device 1 has the function of modulating the light beam L. Consequently, after the light beam L passes through the optical lens, a designed optical effect is generated. For example, the optical lens is capable of correcting the spherical aberration. According to different optical requirements, a lens module with different types of lenses or plural lenses is provided to produce the desired optical effect. The manufacturer of the image capturing device desires to achieve the good optical effect. Generally, the optical lens 11 is made of plastic material or glass material. The heat resistance of the optical lens made of the glass material is superior to the heat resistance of the optical lens made of plastic material. However, the fabricating cost of the optical lens made of the glass material is higher.

Therefore, there is a need of providing an image capturing device with cost-effectiveness and capable of generating good optical effect.

### SUMMARY OF THE INVENTION

An object of the present invention provides an image capturing device with cost-effectiveness and capable of generating good optical effect.

In accordance with an aspect of the present invention, there is provided an image capturing device for shooting a target object to acquire an image of the target object. The image capturing device includes an optical lens module and an optical sensor. The optical lens module is installed in the image capturing device. A light beam passes through the optical lens module. The optical lens module includes a first optical lens, a second optical lens, a third optical lens, a first combined lens assembly and a second combined lens assembly. The first optical lens is located at a first end of the optical lens module. The second optical lens is located beside the first optical lens. The third optical lens is located beside the second optical lens. The first combined lens assembly is located at a second end of the optical lens module. The first combined lens assembly is a combination of a first glass lens and a silicone lens. The second combined lens assembly is arranged between the third optical lens and the first combined lens assembly. The optical sensor is installed in the image capturing device and located beside the optical lens module. After the light beam passing through the optical lens module is received by the optical sensor, the image corresponding to the target object is generated.

From the above descriptions, the present invention provides the image capturing device. The first combined lens assembly comprises the silicone lens. The silicone resin material of the silicone lens has good thermal stability. Consequently, the silicone lens can be stably used in the environment with a large temperature change. Since the silicone lens is resistant to ultraviolet light and is not easily yellowed, the first combined lens assembly can alleviate the light decay phenomenon and is suitable for use in an outdoor environment. Since the silicone resin material has a high light transmittance, the light utilization efficacy of the light beam can be improved. Moreover, the first combined lens assembly can be formed into an aspherical lens by an injection molding process. The optical effect of the non-spherical lens for correcting optical aberrations is better.

Moreover, in case that the first combined lens assembly is formed by an injection molding process, the lens with the higher thickness ratio can be produced according to the practical requirements. In comparison with the glass lens and the plastic lens, the lens with the higher thickness ratio has expansive applications. The high thickness ratio indicates that the ratio of the center thickness to the periphery thickness of the lens is high. Moreover, the fabricating cost of forming the aspherical first combined lens assembly is lower than the fabricating cost of forming the aspherical glass lens.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic cross-sectional side view illustrating the structure of a conventional image capturing device;

FIG. 2 is a schematic cross-sectional side view illustrating a portion of an image capturing device according to a first embodiment of the present invention;

FIG. 3 is a schematic cross-sectional side view illustrating a portion of an image capturing device according to a second embodiment of the present invention;

FIG. 4 is a schematic cross-sectional side view illustrating a first combined lens assembly of an image capturing device according to a third embodiment of the present invention; and

FIG. 5 is a schematic cross-sectional side view illustrating a first combined lens assembly of an image capturing device according to a fourth embodiment of the present invention.

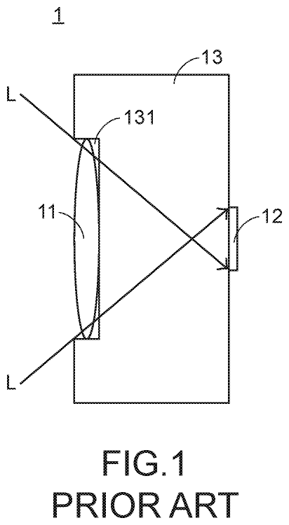

### DETAILED DESCRIPTION OF THE PREFERRED EMBODIMENT

For solving the drawbacks of the conventional technologies, the present invention provides an image capturing device.

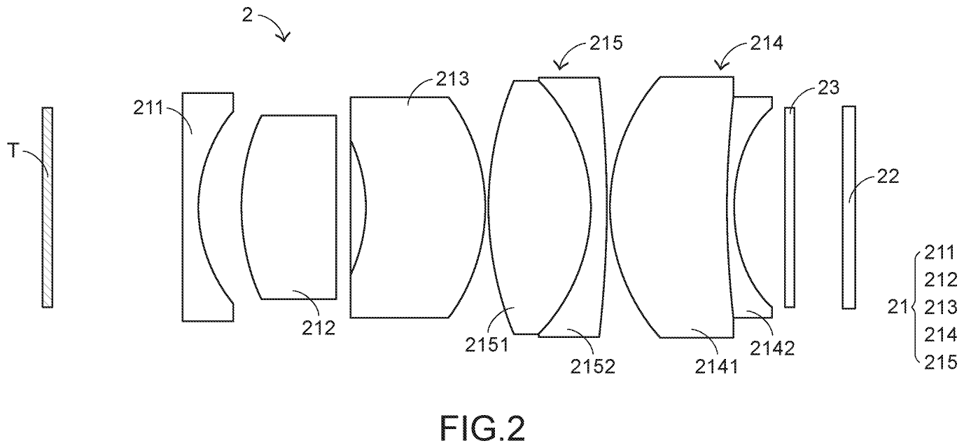

FIG. 2 is a schematic cross-sectional side view illustrating a portion of an image capturing device according to a first embodiment of the present invention. The image capturing device 2 is used for shooting a target object T to acquire the image of the target object T. The image capturing device 2 comprises a casing (not shown), an optical lens module 21, an optical sensor 22 and a filter 23. The optical lens module 21 is installed in the casing of the image capturing device 2. After a light beam (not shown) passes through the optical lens module 21, an optical effect corresponding to the optical lens module 21 is generated. The optical sensor 22 is installed in the image capturing device 2 and located beside the optical lens module 21. After the light beam passing through the optical lens module 21 is received by the optical sensor 22, the image corresponding to the target object T is generated. In an embodiment, the optical sensor 22 is a sensing chip. The operations of the sensing chip to generate the image are well known to those skilled in the art, and are not redundantly described herein.

The optical lens module 21 comprises a first optical lens 211, a second optical lens 212, a third optical lens 213, a first combined lens assembly 214 and a second combined lens assembly 215. The first combined lens assembly 214 comprises a first glass lens 2141 and a silicone lens 2142. The second combined lens assembly 215 comprises a second glass lens 2151 and a third glass lens 2152. The filter 23 is arranged between the silicone lens 2142 and the optical sensor 22. The filter 23 is used for filtering the invisible light.

The first optical lens 211 is located at a first end of the optical lens module 21. The second optical lens 212 is located beside the first optical lens 211. The first optical lens 211 and the second optical lens 212 are used for correcting the spherical aberration, the distortion and the field curvature of the image. The third optical lens 213 is located beside the second optical lens 212. The third optical lens 213 is used for corresponding the spherical aberration and the field curvature of the image. In an embodiment, the focal length F1 of the first optical lens 211 and the second focal length F2 of the second optical lens 212 satisfy the following mathematical relationship:

$$0.9 < \vert \frac{F 1}{F 2} \vert < 1.1 .$$

In an embodiment, the first optical lens 211 has the negative diopter, the second optical lens 212 has the positive diopter, and the third optical lens 213 has the positive diopter. In an embodiment, the first optical lens 211, the second optical lens 212 and the third optical lens 213 are made of glass material. It is noted that the materials of these optical lenses are not restricted. For example, in another embodiment, the first optical lens, the second optical lens and the third optical lens are made of plastic material. Alternatively, the first optical lens, the second optical lens and the third optical lens are made of glass material or plastic material.

The first combined lens assembly 214 is located at a second end of the optical lens module 21. That is, the first combined lens assembly 214 is located near the optical sensor 22. The first glass lens 2141 of the first combined lens assembly 214 is located near the second combined lens assembly 215. The silicone lens 2142 of the first combined lens assembly 214 is located near the optical sensor 22. The first glass lens 2141 and the silicone lens 2142 are used for correcting the distortion, the field curvature and the coma aberration of the image. In an embodiment, the focal length F6 of the first glass lens 2141 and the focal length F7 of the silicone lens 2142 satisfy the following mathematical relationship:

$$\frac{F 6}{F 7} < 0.$$

In an embodiment, the first glass lens 2141 has the positive diopter, and the silicone lens 2142 has the negative diopter. The first glass lens 2141 and the silicone lens 2142 are combined as the first combined lens assembly 214 through an injection molding process. It is noted that the examples of the first combined lens assembly are not restricted. For example, in another embodiment, the first glass lens has the negative diopter, and the silicone lens has the positive diopter.

The second combined lens assembly 215 is arranged between the third optical lens 213 and the first combined lens assembly 214. The second glass lens 2151 of the second combined lens assembly 215 is located near the third optical lens 213. The third glass lens 2152 of the second combined lens assembly 215 is located near the first glass lens 2141. The second glass lens 2151 and the third glass lens 2152 are used for correcting the lateral color and the spherical aberration. In an embodiment, the second glass lens 2151 and the third glass lens 2152 are combined as the second combined lens assembly 215 through an adhesive. In an embodiment, the second glass lens 2151 has the positive diopter, and the third glass lens 2152 has the negative diopter. An example of the adhesive for combining these two glass lenses is a UV adhesive. In the , the second combined lens assembly 215, the ABBE number V4 of the second glass lens 2151 and the ABBE number V5 of the third glass lens 2152 satisfy the following mathematical relationship:

32<|V4−V5|<42

As mentioned above, the optical lens module 21 can provide diverse optical effects. It is noted that the optical effects are not restricted. For example, the third optical lens 213, the second glass lens 2151, the third glass lens 2152, the first glass lens 2141 and the silicone lens 2142 further provide the function of correcting the astigmatism of the image.

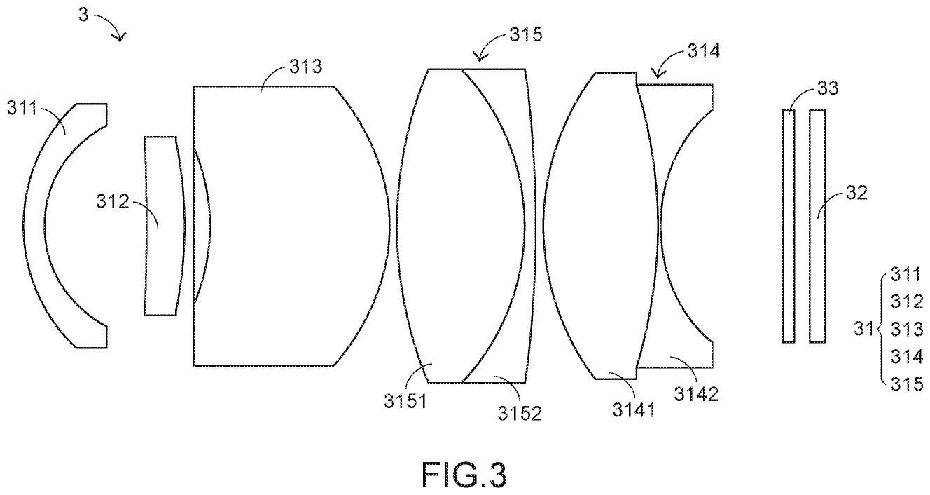

The present invention further provides a second embodiment, which is distinguished from the first embodiment. FIG. 3 is a schematic cross-sectional side view illustrating a portion of an image capturing device according to a second embodiment of the present invention. The image capturing device 3 comprises a casing (not shown), an optical lens module 31, an optical sensor 32 and a filter 33.

The optical lens module 31 comprises a first optical lens 311, a second optical lens 312, a third optical lens 313, a first combined lens assembly 314 and a second combined lens assembly 315. The first combined lens assembly 314 comprises a first glass lens 3141 and a silicone lens 3142. The second combined lens assembly 315 comprises a second glass lens 3151 and a third glass lens 3152.

The structures and arrangements of the components of the image capturing device 3 which are identical to those of the first embodiment are not redundantly described herein. Moreover, the mathematical relationships between the associated lenses of this embodiment are identical to the first embodiment. In comparison with the first embodiment, the image capturing device 3 provides different optical effects.

The optical effects provided by the image capturing device 3 will be described as follows. The first optical lens 311 and the third optical lens 313 have the functions of correcting the spherical aberration and the field curvature of the image. The second glass lens 3151 and the third glass lens 3152 have the function of correcting the lateral color and the spherical aberration. The first glass lens 3141 and the silicone lens 3142 have the function of correcting the distortion, the field curvature and the coma aberration of the image. The second optical lens 312, the second glass lens 3151, the third glass lens 3152, the first glass lens 3141 and the silicone lens 3142 have the function of correcting the astigmatism of the image.

The diopters of associated lenses of the image capturing device 3 will be described as follows. The first optical lens 311 has the negative diopter. The second optical lens 312 has the positive diopter. The third optical lens 313 has the positive diopter. The second glass lens 3151 has the positive diopter. The third glass lens 3152 has the negative diopter. The first glass lens 3141 has the positive diopter. The silicone lens 3142 has the negative diopter. The diopters of these lenses are identical to those of the first embodiment. It is noted that the diopters of these lenses are not restricted. In the following embodiment, the diopters of the lenses of the first combined lens assembly are different from this embodiment.

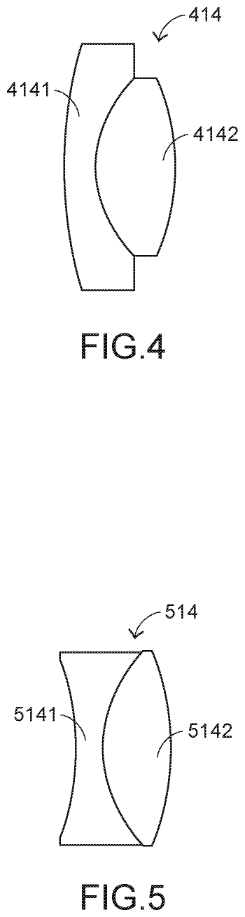

FIG. 4 is a schematic cross-sectional side view illustrating a first combined lens assembly of an image capturing device according to a third embodiment of the present invention. As shown in FIG. 4, the first combined lens assembly 414 of the image capturing device (not shown) comprises a first glass lens 4141 and a silicone lens 4142. In this embodiment, the first glass lens 4141 has the negative diopter, and the silicone lens 4142 has the positive diopter.

FIG. 5 is a schematic cross-sectional side view illustrating a first combined lens assembly of an image capturing device according to a fourth embodiment of the present invention. As shown in FIG. 5, the first combined lens assembly 514 of the image capturing device (not shown) comprises a first glass lens 5141 and a silicone lens 5142. In this embodiment, the first glass lens 5141 has the negative diopter, and the silicone lens 5142 has the positive diopter.

In the above two embodiments, the first glass lenses 4141 and 5141 and the silicone lenses 4142 and 5142 have to match corresponding lenses to form the complete optical lens modules and provide the desired optical effects. These optical lenses may be varied according to the practical requirements. Consequently, these optical lenses are not shown in FIGS. 4 and 5.

From the above descriptions, the present invention provides the image capturing device. The first combined lens assembly comprises the silicone lens. The silicone resin material of the silicone lens has good thermal stability. Consequently, the silicone lens can be stably used in the environment with a large temperature change. Since the silicone lens is resistant to ultraviolet light and is not easily yellowed, the first combined lens assembly can alleviate the light decay phenomenon and is suitable for use in an outdoor environment. Since the silicone resin material has a high light transmittance, the light utilization efficacy of the light beam can be improved. Moreover, the first combined lens assembly can be formed into an aspherical lens by an injection molding process. The optical effect of the non-spherical lens for correcting optical aberrations is better.

Moreover, in case that the first combined lens assembly is formed by an injection molding process, the lens with the higher thickness ratio can be produced according to the practical requirements. In comparison with the glass lens and the plastic lens, the lens with the higher thickness ratio has expansive applications. The high thickness ratio indicates that the ratio of the center thickness to the periphery thickness of the lens is high. Moreover, the fabricating cost of forming the aspherical first combined lens assembly is lower than the fabricating cost of forming the aspherical glass lens.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An image capturing device for shooting a target object to acquire an image of the target object, the image capturing device comprising:
an optical lens module installed in the image capturing device, wherein a light beam passes through the optical lens module, wherein the optical lens module comprises:
a first optical lens located at a first end of the optical lens module;
a second optical lens located beside the first optical lens;
a third optical lens located beside the second optical lens;
a first combined lens assembly located at a second end of the optical lens module, wherein the first combined lens assembly is a combination of a first glass lens and a silicone lens; and
a second combined lens assembly arranged between the third optical lens and the first combined lens assembly; and
an optical sensor installed in the image capturing device and located beside the optical lens module, wherein after the light beam passing through the optical lens module is received by the optical sensor, the image corresponding to the target object is generated.

2. The image capturing device according to claim 1, wherein the second combined lens assembly is a combination of a second glass lens and a third glass lens, and the second glass lens and the third glass lens are combined together through an adhesive.

3. The image capturing device according to claim 1, wherein at least one of the first optical lens, the second optical lens and the third optical lens is made of glass material or plastic material.

4. The image capturing device according to claim 2, wherein an ABBE number V4 of the second glass lens and an ABBE number V5 of the third glass lens satisfy a following mathematical relationship:
32<|V4−V5|<42

5. The image capturing device according to claim 2, wherein the second glass lens has positive diopter, and the third glass lens has negative diopter.

6. The image capturing device according to claim 1, wherein the first glass lens and the silicone lens are combined as the first combined lens assembly through an injection molding process.

7. The image capturing device according to claim 1, wherein a focal length F6 of the first glass lens and a focal length F7 of the silicone lens satisfy a following mathematical relationship:
$$\frac{F 6}{F 7} < 0.$$

8. The image capturing device according to claim 1, wherein the first optical lens has negative diopter, the second optical lens has positive diopter, and the third optical lens has positive diopter.

9. The image capturing device according to claim 1, wherein a focal length F1 of the first optical lens and a second focal length F2 of the second optical lens satisfy a following mathematical relationship:
$$0.9 < \vert \frac{F 6}{F 7} \vert < 1.1 .$$

10. The image capturing device according to claim 1, wherein the image capturing device further comprises a filter, wherein the filter is arranged between the silicone lens and the optical sensor for filtering invisible light.
